(19) United States
(12) Patent Application Publication
(10) Pub. No.: US 2012/0206612 A1
(43) Pub. Date: Aug. 16, 2012

(54) TEST TARGET FOR COLOR CALIBRATING A CAMERA AND LENS COMBINATION

(76) Inventors: C. DAVID TOBIE, Mount Vernon, ME (US); Shawn Clark, Hamilton, NJ (US); Taeyoung Park, Princeton, NJ (US)

(21) Appl. No.: 13/025,919

(22) Filed: Feb. 11, 2011

(51) Int. Cl. H04N 17/02

(52) U.S. Cl. 348/188

(57) ABSTRACT

In one embodiment, the present invention is a test target for color calibrating a camera and lens combination. One embodiment of a test target for use in color calibrating a camera and lens combination includes a first substantially flat plane, the first substantially flat plane including a first magnetic support surface, a second substantially flat plane, the second substantially flat plane including a second magnetic support surface, and a hinge connecting the first substantially flat plane to the second substantially flat plane.

### FIELD OF THE INVENTION

The present invention generally relates to the field of photography, and more specifically relates to the color calibration of image capturing devices.

### BACKGROUND

Every camera make, model, and individual chip records color in a different way. These camera sensors do not “see” in the same way that the human eye sees, and camera manufacturers go to great lengths to manipulate the data captured by their cameras so that realistic images can be produced. However, many camera users have little knowledge of or control over the manner in which the data is manipulated.

### SUMMARY OF THE INVENTION

In one embodiment, the present invention is a test target for color calibrating a camera and lens combination. One embodiment of a test target for use in color calibrating a camera and lens combination includes a first substantially flat plane, the first substantially flat plane including a first magnetic support surface, a second substantially flat plane, the second substantially flat plane including a second magnetic support surface, and a hinge connecting the first substantially flat plane to the second substantially flat plane.

### BRIEF DESCRIPTION OF THE DRAWINGS

The teachings of the present invention can be readily understood by considering the following detailed description in conjunction with the accompanying drawings, in which:

FIG. 1 is a schematic diagram illustrating one embodiment of a test target for color calibrating a camera and lens combination, according to the present invention;

FIG. 2 is a schematic diagram illustrating the assembly of one half of the test target illustrated in FIG. 1; and

FIG. 3 is a schematic diagram illustrating one example of a card, such as the cards illustrated in FIGS. 1 and 2.

### DETAILED DESCRIPTION

In one embodiment, the present invention is a test target for color calibrating a camera and lens combination. Embodiments of the invention automatically account for variations in color control and color consistency at the image capture stage of the digital workflow. In particular, embodiments of the invention produce a custom camera and lens calibration in the form of an adjustment that compensates for the characteristics of the light source and the camera sensors, thereby facilitating more accurate color reproduction in the images captured.

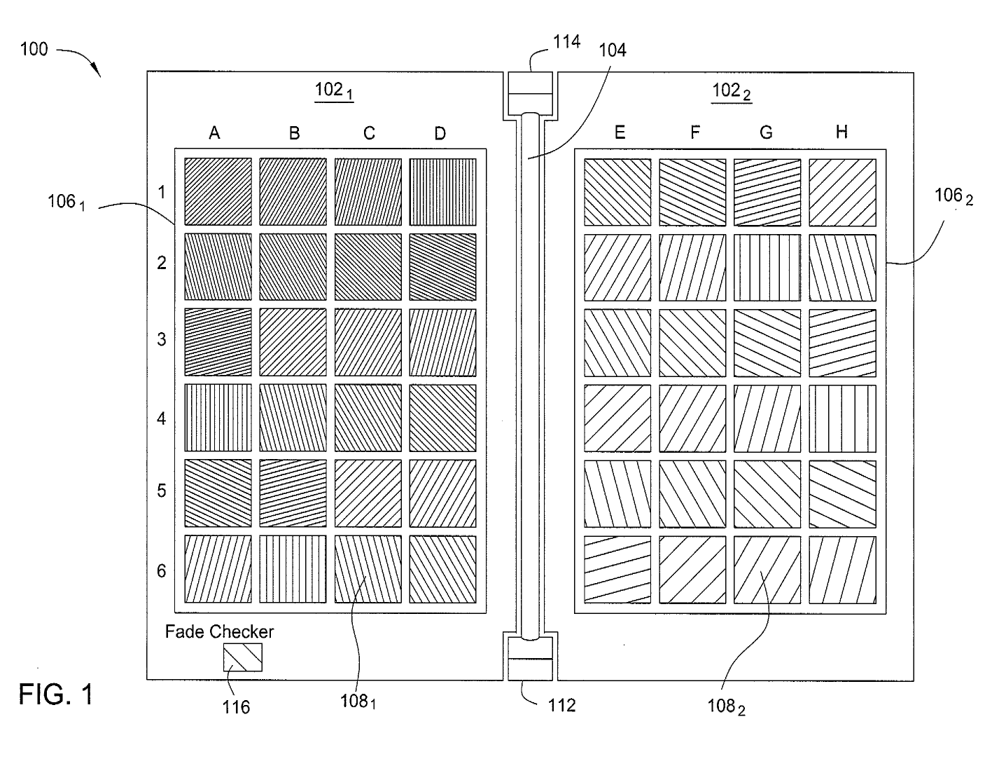

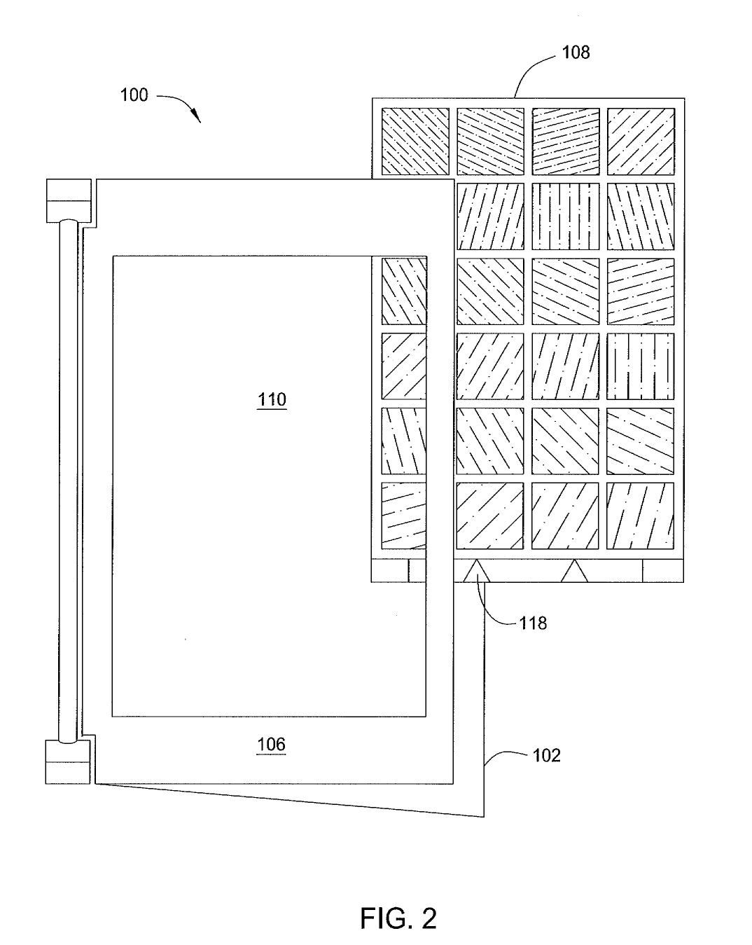

FIG. 1 is a schematic diagram illustrating one embodiment of a test target 100 for color calibrating a camera and lens combination, according to the present invention. FIG. 2 is a schematic diagram illustrating the assembly of one half of the test target 100 illustrated in FIG. 1. Referring simultaneously to FIGS. 1 and 2, as illustrated, the test target 100 is configured as a portable diptych comprising two substantially flat plates 102₁-102₂ (hereinafter collectively referred to as “plates 102”) attached at a hinge 104. In one embodiment, the plates 102 and/or the hinge 104 are at least partially formed from a rigid resin material.

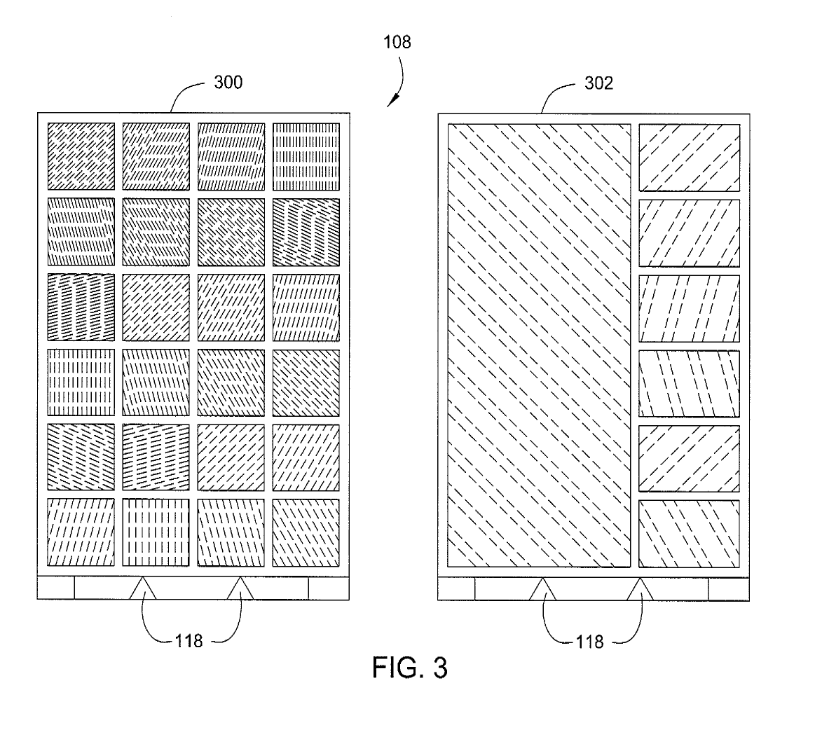

Each of the plates 102 comprises a window 106₁-106₂ (hereinafter collectively referred to as “windows 106”). A card 108₁-108₂ (hereinafter collectively referred to as “cards 108”) is positioned within each of the windows 106. Each of the cards 108 further comprises a plurality of spectrally engineered color samples printed thereon. Although the color samples are illustrated in FIG. 1 (as well as in FIGS. 2 and 3, discussed below) using different patterns or hatchings, this does not indicate that the color samples are necessarily patterned. Rather, the different patterns are used to visually indicate in the black and white line drawings that the color samples are different colors. In one embodiment, each of the cards 108 comprises twenty-four rectangular color samples of different colors, where the color samples are arranged in a grid formation. Thus, collectively, the two cards 108 present a total of forty-eight color samples for use with the test target 100. In one embodiment, the color samples include a plurality of different skin tone colored samples (e.g., for use in portrait and fashion photography).

In one embodiment, the support surfaces of the windows 106 (i.e., the surfaces beneath the cards 108, which are not visible in FIG. 1 but are indicated by the reference numeral 110 in FIG. 2) are formed of a magnetic material. The windows themselves are then formed of magnets that are positioned over the cards 108 so as to hold the cards 108 in place against the support surfaces 110. This also allows the cards 108 to be easily removed and replaced, as illustrated in FIG. 2.

In one embodiment, at least one of the windows 106 further includes a fade checker window 116. The fade checker window 116 comprises a cut out in the window 106 that allows an aging indicator 118 on the card 108 positioned beneath the window 106 to be viewed. In one embodiment, the aging indicator 118 comprises a strip or patch on the perimeter of the card 108 that fades or changes color when exposed to a threshold amount of ultraviolet light. When the aging indicator 118 fades or changes color, this is an indication that the card 108 should be replaced. As illustrated in FIGS. 2 and 3, the card 108 may include more than one aging indicator 118. One of these aging indicators 118 may be protected from ultraviolet exposure (e.g., concealed beneath the plate 102 so that it is not visible through the window 106) and used as a reference against which to compare the aging indicator 118 that is visible through the fade checker window 116. In another embodiment, a reference strip or patch that matches the protected (concealed) aging indicator 118 is provided for color comparison and fade assessment.

The hinge 104 allows the two plates 102 to be rotated toward one another (and into contact with one another), so that the target 100 can be folded compactly into a case for transport. In use, the hinge 104 allows the two plates 102 to be rotated away from one another to form a free-standing target in which the plurality of color samples is visible. In one embodiment, the test target 100 further comprises a tripod mount 112 positioned at a first end of the hinge 104 that allows the test target 100 to be incorporated in a variety of scene contexts.

In a further embodiment still, a gray calibration device mount 114 is also provided at an opposite second end of the hinge 104. The gray calibration device mount 114 allows a gray calibration device (e.g., a gray card or functionally equivalent device, such as the camera calibration tool disclosed in U.S. patent application Ser. No. 12/577,462) to be mounted to the test target 100 for adding black traps and spectral highlights.

FIG. 3 is a schematic diagram illustrating one example of a card 108, such as the cards 108 illustrated in FIGS. 1 and 2. As illustrated, each of the cards 108 comprises a first side 300 and an opposite second side 302. The first side 300 of the card 108 comprises a plurality of rectangular color samples, as illustrated in FIGS. 1 and 2. The second side 302 of the card 108 comprises a set of achromatic samples. In one embodiment, the set of achromatic samples comprises one large rectangular achromatic sample and six smaller rectangular achromatic samples positioned along one side of the large rectangular achromatic sample. In one embodiment, larger rectangular achromatic sample comprises a neutral gray target, while the six smaller rectangular achromatic samples collectively comprise a gray ramp. As discussed above, the cards 108 may be replaced when they have been exposed to a threshold amount of ultraviolet light, as indicated by the aging indicators 118.

The test target 100 cooperates with a software program to ensure that consistent color is captured from day to day and camera to camera. In particular, the software program uses images of the test target to compute color adjustments that can be incorporated into the imaging workflow with RAW image format import software. Moreover, the neutral gray target and gray ramp provided on the cards allows a user to perform in-camera white balance and visual neutrality analyses.

Although various embodiments which incorporate the teachings of the present invention have been shown and described in detail herein, those skilled in the art can readily devise many other varied embodiments that still incorporate these teachings.

What is claimed is:

1. A test target for use in color calibrating a camera and lens combination, comprising:
a first substantially flat plane, the first substantially flat plane including a first magnetic support surface;
a second substantially flat plane, the second substantially flat plane including a second magnetic support surface; and
a hinge connecting the first substantially flat plane to the second substantially flat plane.

2. The test target of claim 1, further comprising:
a first window positioned over the first substantially flat plane; and
a second window positioned over the second substantially flat plane.

3. The test target of claim 2, wherein the first window and the second window comprise magnets.

4. The test target of claim 2, further comprising:
at least one removable card positioned between the first substantially flat plane and the first window or between the second substantially flat plane and the second window, the at least one removable card having a plurality of color samples of different colors printed thereon.

5. The test target of claim 4, wherein the plurality of color samples are arranged in a grid formation.

6. The test target of claim 4, wherein the at least one removable card comprises:
a first side having the plurality of color samples printed thereon; and
a second side having a plurality of achromatic samples printed thereon.

7. The test target of claim 6, wherein the plurality of achromatic samples comprises:
a neutral gray target; and
a gray ramp.

8. The test target of claim 4, wherein the at least one removable card comprises:
an aging indicator positioned on a perimeter of the at least one removable card.

9. The test target of claim 8, wherein the aging indicator comprises a patch that changes color when exposed to a threshold amount of ultraviolet light.

10. The test target of claim 9, further comprising:
a reference aging indicator comprising a patch that changes color when exposed to a threshold amount of ultraviolet light, where the reference aging indicator is not visible through the first window or the second window.

11. The test target of claim 8, wherein at least one of the first window and the second window comprises:
a fade checker window that allows the aging indicator to be viewed when the card is positioned beneath the at least one of the first window and the second window.

12. The test target of claim 1, wherein the hinge allows enough rotation for the first substantially flat plane to be rotated into contact with the second substantially flat plane.

13. The test target of claim 1, further comprising:
a tripod mount positioned at a first end of the hinge.

14. The test target of claim 1, further comprising:
a gray calibration device mount positioned at a first end of the hinge.

15. The test target of claim 1, wherein at least a portion of the test target is formed of a resin.

16. A card configured as a test target for use in color calibrating a camera and lens combination, the card comprising:
a plurality of color samples printed on a first side of the card; and
an aging indicator positioned on a perimeter of the first side of the card.

17. The card of claim 16, wherein the plurality of color samples is arranged in a grid formation.

18. The card of claim 16, wherein the card further comprises:
a plurality of achromatic samples printed on a second side of the card.

19. The card of claim 17, wherein the plurality of achromatic samples comprises:
a neutral gray target; and
a gray ramp.

20. The card of claim 16, wherein the aging indicator comprises a patch that changes color when exposed to a threshold amount of ultraviolet light.
